(19) United States
(12) Patent Application Publication
(10) Pub. No.: US 2016/0247372 A1
(43) Pub. Date: Aug. 25, 2016

(54) SECURITY BARRIER SYSTEM

(71) Applicant: Roger P. Sylvester, Unionville, CT (US)

(72) Inventor: Roger P. Sylvester, Unionville, CT (US)

(21) Appl. No.: 15/147,631

(22) Filed: May 5, 2016

Related U.S. Application Data
(63) Continuation of application No. 14/484,554, filed on Sep. 12, 2014.
(60) Provisional application No. 61/879,813, filed on Sep. 19, 2013.

(51) Int. Cl. G08B 15/00; E05F 15/72; E05F 15/73; G08B 25/12; E05F 15/79; E06B 5/10; E06B 5/01; E06B 3/48; E05F 15/60; E05F 15/77

(52) U.S. Cl. CPC G08B 15/007; E05F 15/60; E05F 15/72; E05F 15/73; E05F 15/77; E05F 15/79; E06B 5/10; E06B 5/01; E06B 3/48; E06B 5/106; G08B 25/12

(57) ABSTRACT

A deployable security barrier system (10, 10′, 110) is formed by deploying bullet-proof or bullet-resistant barrier fence sections (26, 26′, 28, 28′). A control system which enables rapid deployment of the sections to form across a hallway or other closed area a barrier fence (30, 130) which is high enough to prevent or at least greatly impede a person from passing through or over the fence. The barrier fence (30, 130) may extend from floor to ceiling or to a fixed barrier extending downwardly from the ceiling. The barrier fence may have at least one transparent section (26a, 28a) to enable law enforcement or security persons to observe the situation on the other side of the barrier fence. The controls also permit at least partial opening of the barrier fence to enable law enforcement or security personnel to pass through it as needed. Supplemental alarm and/or distracting and/or disabling agencies may be deployed in addition to the barrier fence (30, 130).

### CROSS-REFERENCE TO RELATED APPLICATIONS

This application is a continuation application of patent application Ser. No. 14/484,554, filed on Sep. 12, 2014, which claims the benefit of priority of provisional patent application Ser. No. 61/879,813, filed on Sep. 19, 2013, each entitled “Security Barrier System”.

### BACKGROUND OF THE INVENTION

1. Field of the Invention

The present invention relates to a security barrier system which may be rapidly deployed to provide one or more barrier fences to control or prevent access or movement by one or more intruders into or within a protected or security area, and to a method of controlling a security area by deployment of such security barrier system.

2. Related Art

Barrier control systems are known in which a gate or barrier is deployed to control access or limit movement of persons within a security area. For example, see U.S. Patent Application Publication US 2009/0096572 A1 of Todd Bosik et al., published on Apr. 16, 2009, for “Breach Control Barrier System”.

### SUMMARY OF THE INVENTION

Generally, the present invention provides a security barrier system comprised of a barrier fence operatively connected to a control system which may be operated to rapidly deploy the barrier fence from an undeployed, i.e., stowed, configuration to a deployed configuration in which the deployed barrier fence prevents or at least greatly inhibits movement of a person or persons through or into an area to be secured, i.e., a security area.

The barrier fence may be at least partly openable from either side thereof by authorized persons such as law enforcement or other security personnel, who have been provided with an access device, or by operation of the control system. Such personnel may at least partially open the barrier fence to provide a limited access opening at least large enough to permit access through the barrier fence by authorized personnel and/or permit the training of weapons upon persons not authorized to be in the security area.

In accordance with the present invention there is provided a security barrier system for closing a security area to passage therethrough by a person or persons, the barrier system comprising the following components. At least one deployable barrier fence and a control system operatively connected to the barrier fence to move the barrier fence between an undeployed position in which the security area is open to passage therethrough by a person or persons, and a fully deployed position in which the barrier fence closes the security area to any such passage therethrough. The barrier fence is configured to enable, at a selected time after the barrier fence is in the fully deployed position, the formation in the barrier fence of a limited access opening to the security area.

One aspect of the present invention provides for the control system and the barrier fence to be configured to provide the limited access opening by moving the barrier fence from its fully deployed position to an intermediate, partially deployed position between its fully deployed and undeployed positions, to thereby provide a limited access opening to the security area through the partially deployed barrier fence.

Another aspect of the present invention provides that the barrier fence is configured to open at least one section of the fully deployed barrier fence to provide at least one limited access opening to the security area through the fully deployed barrier fence.

Other aspects of the present invention may provide one or more of the following features, alone or in any suitable combination: the barrier fence may be comprised of a ballistic material along substantially its entire deployed length; at least a portion of the barrier fence may be sufficiently transparent to permit observation of the security area through the barrier fence; the barrier fence may comprise a pair of barrier fence sections which are movable in a horizontal travel path between the undeployed and fully deployed positions and the free ends of the barrier fence sections may abut or preferably overlap each other when in the fully deployed position; at least the overlapped free ends of the barrier fence may be transparent and may be comprised of a ballistic glass material; the barrier fence may be comprised of a ballistic material along substantially the entire deployed length; the barrier fence may be comprised of a series of hinged panels which are folded upon each other into a stack when the barrier fence is in its undeployed position, and which open into a linear array of panels as the barrier fence is moved into its deployed position; the security barrier system may further comprise a detection system which detects the presence of an unauthorized person or person in the security area and transmits an alarm to alert security personnel to activate the control system to move the barrier fence to its fully deployed position; in a related aspect of the present invention, the detection system alarm may automatically signal the control system to move the barrier fence to its fully deployed position; the barrier fence when in its undeployed position may be comprised of a roll of material which is unrolled into a linear configuration as the barrier fence is moved into its deployed position; and the security barrier system may further comprise one or more communication paths which automatically transmit signals to a remote emergency response facility when the control system is activated to move the barrier fence from its undeployed position to its fully deployed position.

In accordance with a method aspect of the present invention, there is provided a method of controlling a security area which has been entered by one or more unauthorized persons, the method comprising the following steps. One or more barrier fences of a security barrier system are deployed from an undeployed position in which the security area is open to passage therethrough, to a fully deployed position in which the one or more barrier fences close the security area to such passage. The barrier fences are positioned to fully enclose the security area and thereby enclose such unauthorized person or persons within the security area.

Other aspects of the method of the present invention provide for one or more of the following, in any suitable combination: operating at least one of the barrier fences to form, at a selected time after the barrier fences are in their fully deployed positions, a limited access opening in at least one of the barrier fences; when at least one of the barrier fences is transparent at least at a portion thereof, observing the one or more unauthorized persons through the transparent portion or portions; and when the barrier system further comprises an alarm system which detects the presence of one or more unauthorized persons in the security area, providing for the alarm system to automatically trigger a control system operatively connected to the barrier fences to move the barrier fences to their fully deployed position.

In accordance with one aspect of the invention, the security barrier system is comprised of a barrier fence which is moveable by one or more drive motors from a stowed to a deployed configuration.

In accordance with another aspect of the invention, the barrier fence is made of a ballistic material which is capable of stopping penetration by small arms fire, at least from small arms up to and including .223 caliber.

Still another aspect of the invention provides that at least a portion of the barrier fence is transparent in order that law enforcement or other security personnel may observe the area beyond the deployed barrier fence.

Yet another aspect of the invention provides for two sections of the barrier fence to be disposed opposite each other, for example, on opposite walls of a hallway or other area to be secured. Upon deployment, the two barrier fence sections are moved horizontally towards each other until their leading edges meet or preferably overlap. The overlapped portions may be, but need not be, at the center of the fully deployed barrier fence.

In one aspect of the invention, there is provided a transparent section of the deployed barrier fence, the transparent section being comprised of, for example, ballistic (bulletproof or bullet-resistant) glass and/or plastic. The transparent section may be provided at the overlapped portion of the deployed barrier fence.

Yet another aspect of the present invention provides for the barrier fence to be stowed above the area in which it is to be deployed, for example, adjacent to or within the ceiling of such area, and to be deployed downwardly in a vertical direction into contact or near contact with the floor.

Another aspect of the present invention provides that drive motors of the security barrier installation may comprise one or more electric, pneumatic or hydraulic drive motors connected to deploy the barrier fence or fences upon receipt of a deployment signal from the master control. The deployment signal may emanate from a control area through electrical conducting wires, or by any suitable wireless signals, or a combination thereof. The control system may also comprise a secondary control operatively connected to the barrier fence to permit at least partial un-deployment of the fence, i.e., return of the barrier fence towards or to its stowed, undeployed configuration.

Still another aspect of the present invention provides for a master control to remotely operate the drive motor or motors to deploy the barrier fence or fences, which master control may be set up in a secure master control area which may also provide for communication with a remote emergency response facility such as a police station or other security office which receives an alarm signal when the security barrier fence has been deployed, to signal that assistance is needed at the installation site.

Other aspects of the present invention will become clear from the appended drawings and the following description.

### BRIEF DESCRIPTION OF THE DRAWINGS

FIG. 1 is a perspective view of an undeployed security barrier installation in accordance with one embodiment of the present invention;

FIG. 2 is a view corresponding to that of FIG. 1 with the conventional lockers omitted, and showing a partially deployed barrier fence of the installation of FIG. 1;

FIG. 3 is a plan view of the installation of FIG. 2, with the barrier fence partially deployed and a part of the overhead track broken away;

FIG. 3A is an elevation view taken along line A-A of FIG. 3 with parts omitted and showing the barrier fence partially deployed;

FIG. 4 is a plan view corresponding to that of FIG. 3 but showing the barrier fence fully deployed;

FIG. 4A is an elevation view taken along line A-A of FIG. 4 with parts omitted and showing the barrier fence fully deployed;

FIG. 5 is a schematic plan view showing intersecting corridors of a building, such as a school building, with four security barrier installations schematically shown respectively disposed near the ends of the intersecting corridors;

FIG. 6 is a schematic diagram showing two pairs of drive motors, each pair respectively associated with a security barrier member, for example, a security barrier member of the type illustrated in FIGS. 1-5, and a control area in which are located instruments to control the drive motors and to alert a police station that assistance is needed;

FIG. 7 is a partial plan view, enlarged relative to FIG. 1, of some of the panels of the barrier fence (not visible in FIG. 1 and best seen in FIG. 4A) stored in their undeployed configuration;

FIG. 7A is a partial view showing some of the panels of the embodiment of FIG. 7 in their deployed configuration;

FIG. 7B is enlarged relative to FIG. 7A, and shows the portion of FIG. 7A enclosed by the circle B;

FIG. 8 is a plan view corresponding to that of FIG. 7 showing an alternate embodiment of the panels of the barrier fence stored in their undeployed configuration;

FIG. 8A is a partial view showing some of the panels of the embodiment of FIG. 8 in their deployed configuration;

FIG. 9 is a plan view showing partial deployment of the barrier fence of the embodiment of FIG. 8;

FIG. 10 is a plan view corresponding to that of FIG. 9 but showing an embodiment of the invention wherein the barrier fence comprises a vertically oriented continuous roll of barrier material instead of discrete barrier panels;

FIG. 11 is a perspective view of a barrier installation in accordance with another embodiment of the invention in which storage recesses are formed in opposing walls of a hallway, in which recesses respective halves of an undeployed barrier fence are stored;

FIG. 12 is a schematic elevation view of a ceiling-mounted barrier fence configured to deploy in a vertically descending arc;

FIG. 12A is a view, enlarged relative to FIG. 12, of the portion of FIG. 12 enclosed within circle A; and

FIG. 13 is a cross-sectional view of a bullet and fire-resistant panel suitable for use in the barrier fence of the present invention.

### DETAILED DESCRIPTION OF THE INVENTION

Succinctly stated, the requisites of a crime are the perpetrator's desire to commit the crime and an opportunity to do so. The opportunity to commit the crime of entering a building for purposes of robbery or vandalizing, or for kidnapping or attacking persons within the building, requires sufficient time and sufficient mobility within the building for the perpetrator to carry out his or her nefarious design. This construct is well illustrated by the horrendous events of the morning of Dec. 14, 2012 when an apparently crazed individual broke into the Sandy Hook Elementary School in Newtown, Conn. and shot and killed twenty first-grade students and six educators. After breaking into the school, the perpetrator had time to move freely and without impediment within the corridors of the school, thereby facilitating his unspeakable crime.

The present invention is broadly applicable for use in any location in which prompt deployment of a barrier fence would constrain a perpetrator's movement and delay if not foreclose his ability to commit the crime. The delay will buy time for law enforcement or security personnel to reach the scene in time to prevent or at least reduce the scope of the crime, as well as to limit or eliminate entirely the perpetrator's ability to escape. While the present invention has particular applicability to school buildings, it is equally applicable to other structures including, among others, warehouses, hospitals, airport terminals, court houses, government or private office buildings and apartment buildings.

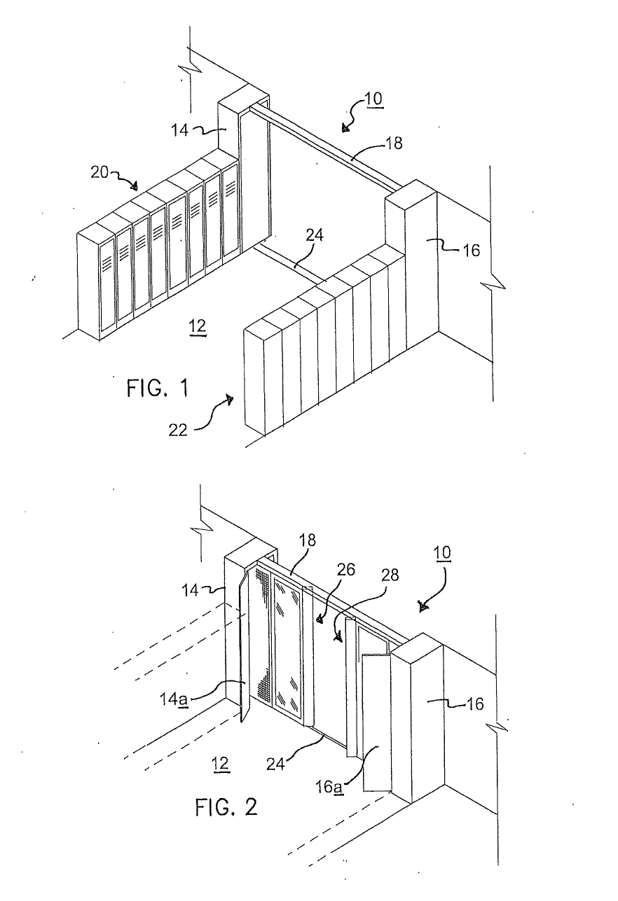

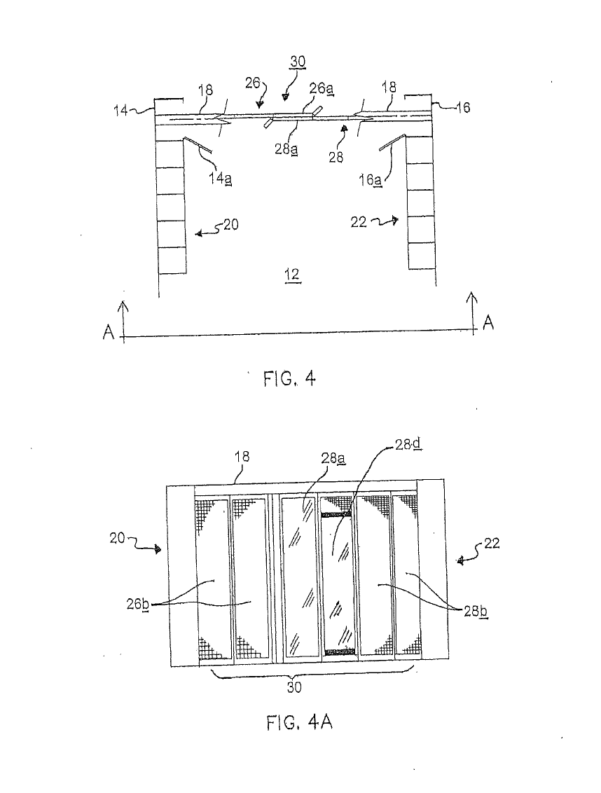

Referring now to FIGS. 1-4A of the drawings, FIG. 1 shows a security barrier installation 10 disposed at the end of a hallway 12 of a school building. The installation comprises a pair of storage lockers 14, 16 disposed on opposite sides of hallway 12 and aligned with each other. An optional overhead track 18 extends between storage lockers 14 and 16 within which are stored respective sections 26, 28 (FIG. 2) of a barrier fence 30 (FIG. 4). Overhead track 18 may be secured to the ceiling (not shown) of hallway 12 or the top of overhead track 18 may abut or be close enough to the ceiling of hallway 12 to prevent a person from passing over overhead track 18. In some cases a fixed barrier (not shown) may extend downwardly from the ceiling of hallway 12 to abut overhead track 18 or be close enough to it to prevent a person from passing between overhead track 18 and the fixed barrier. The overhead track 18 may be omitted and the top of the barrier fence 30 may extend to or be close to the ceiling of hallway 12. In other cases, the barrier fence and overhead track 18, if present, may simply be made high enough to prevent or greatly impede a person from climbing over the barrier fence. In any case, the barrier fence, as more fully described below, may be comprised of hinged panels which may be stowed in storage lockers 14, 16 in a folded, compact configuration and opened to form a linearly extending barrier fence or a section thereof. In the illustrated embodiment, storage lockers 14 and 16 are shown disposed at the end of respective rows 20, 22 of conventional lockers such as those provided for the convenience of students in most middle and high schools. An optional floor track 24 extends along the floor of hallway 12 beneath, parallel to and aligned with overhead track 18. FIG. 1 shows the security barrier installation 10 in its undeployed condition in which egress from and entry into hallway 12 is unimpeded.

The barrier fence, as noted above, is desirably made of a ballistic material, that is, a bullet-proof or bullet-resistant material. The transparent panels of the barrier fence may be made from ballistic glass, sometimes referred to as bullet-proof or bullet-resistant glass. The weight of the deployable barrier fence is a significant factor in preparing an efficient and cost-effective installation. Therefore, it will suffice for many or most installations if the ballistic material at least provides resistance to penetration by small arms bullets, and preferably if the ballistic material meets a national ballistic standard for protection against small arms fire. One such appropriate standard is set forth in U.S. National Institute of Justice Standard NIJ Standard 0108-01, September, 1985. It is preferred that the ballistic material employed in the barrier fence of the present invention prevent penetration by small arms fire from Armor Type I to at least Armor Type III of the following Table, which reproduces Table 1 of NIJ Standard 0108.01, or the equivalent. However, in a given case the “ballistic material”, as that term is used herein and in the claims, may be any suitable ballistic material, including one meeting any of the requirements set forth in the following Table or in other national standards including US Underwriter Laboratories Standard UL 752; Australian Standard AS2343; British Standard BS5051; Chinese Standard GA165; Euronorm Standard EN1063; German Standard DIN52290 and Russian Standard GOST R50963-96. The disclosures of these documents are incorporated by reference herein.

TABLE 1
Test Summary

| | | Performance Requirements | | | | | | | |
|---|---|---|---|---|---|---|---|---|---|
| | | | | | | | | Required | |
| Test Variables | | Nominal | | Suggested | | Required | | Hits Per | |
| Armor | Test | Bullet | | Barrel | | Bullet | | Armor | Permitted |
| Type | Ammunition | Mass | | Length | | Velocity | | Specimen | Penetrations |
| I | 22 LRHV | 2.6 | g | 15 to 16.5 | cm | 320 ± 12 | m/s | 5 | 0 |
| | Lead | 40 | gr | 6 to 6.5 | in | 1050 ± 40 | ft/s | | |
| | 38 Special | 10.2 | g | 15 to 16.5 | cm | 259 ± 15 | m/s | 5 | 0 |
| | RN Lead | 158 | gr | 6 to 6.5 | in | 850 ± 50 | ft/s | | |
| II-A | 357 Magnum | 10.2 | g | 10 to 12 | cm | 381 ± 15 | m/s | 5 | 0 |
| | JSP | 158 | gr | 4 to 4.75 | in | 1250 ± 50 | ft/s | | |
| | 9 mm | 8.0 | g | 10 to 12 | cm | 332 ± 12 | m/s | 5 | 0 |
| | FMJ | 124 | gr | 4 to 4.75 | in | 1090 ± 40 | ft/s | | |
| II | 357 Magnum | 10.2 | g | 15 to 16.5 | cm | 425 ± 15 | m/s | 5 | 0 |
| | JSP | 158 | gr | 6 to 6.5 | in | 1395 ± 50 | ft/s | | |
| | 9 mm | 8.0 | g | 10 to 12 | cm | 358 ± 12 | m/s | 5 | 0 |
| | FMJ | 124 | gr | 4 to 4.75 | in | 1175 ± 40 | ft/s | | |
| III-A | 44 Magnum | 15.55 | g | 14 to 16 | cm | 426 ± 15 | m/s | 5 | 0 |
| | Lead SWC Gas | 240 | gr | 5.5 to 6.25 | in | 1400 ± 50 | ft/s | | |
| | Checked | | | | | | | | |
| | 9 mm | 8.0 | g | 24 to 26 | cm | 426 ± 15 | m/s | 5 | 0 |
| | FMJ | 124 | gr | 9.5 to 10.25 | in | 1400 ± 50 | ft/s | | |
| III | 7.62 mm | 9.7 | g | 56 | cm | 838 ± 15 | m/s | 5 | 0 |
| | 308 Winchester | 150 | gr | 22 | in | 2750 ± 50 | ft/s | | |
| | FMJ | | | | | | | | |
| IV | 30-06 | 10.8 | g | 56 | cm | 868 ± 15 | m/s | 1 | 0 |
| | AP | 166 | gr | 22 | in | 2850 ± 50 | ft/s | | |

Abbreviations:
AP—Armor Piercing
FMJ—Full Metal Jacket
JSP—Jacketed Soft Point
LRHV—Long Rifle High Velocity
RN—Round Nose
SWC—Semi-Wadcutter
m/s = meters per second
ft/s = feet per second

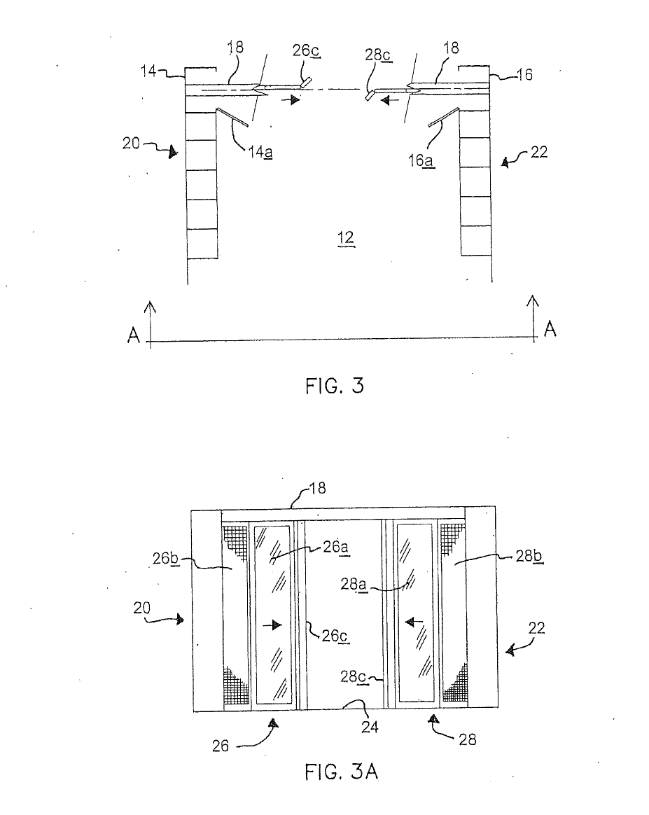

FIG. 2 shows the security barrier installation 10 with barrier fence sections 26, 28 partially deployed. Doors 14a and 16a of storage lockers 14 and 16 are open and one or more drive motors (not shown in FIG. 2) have been actuated, for example, by a master control (not shown), to move barrier fence sections 26, 28 towards each other in the direction shown by the unnumbered arrows in FIGS. 3 and 3A until the free ends (unnumbered) of barrier fence sections 26, 28 meet or, preferably, as illustrated in FIG. 4, overlap when barrier fence 30 is in its fully deployed position.

As best seen in FIG. 3A, barrier fence section 26 is comprised of a transparent end panel 26a and interior panels, only one of which, interior panel 26b, is visible in FIG. 3A. Open doors 14a and 16a of storage lockers 14 and 16 are omitted in FIGS. 3A and 4A for clarity of illustration. Similarly, barrier fence section 28 is comprised of a transparent end panel 28a and interior panels, only one of which, interior panel 28b, is visible in FIG. 3A. Transparent end panel 26a terminates in a bumper 26c affixed to the free end of barrier fence section 26 and transparent end panel 28a terminates in a bumper 28c affixed to the free end of barrier fence section 28. Bumpers 26c and 28c extend vertically for the entire height of their respective end panels and, as best seen in FIG. 3, extend away from each other to ensure smooth passage of transparent end panels 26a and 28a past each other into the overlapping position shown in FIGS. 4 and 4A. In an alternate embodiment, end panels 26a and 28a, whether or not transparent, may abut each other in the fully deployed position. However, some overlapping of the free ends of barrier fence sections 26, 28 is much preferred so as to avoid a “seam” between the barrier fence sections 26, 28. The travel speed of barrier fence sections 26, 28 is desirably high, for example from about 2 to about 10 feet per second, in order to provide a short time-to-closure period as discussed below. Bumpers 26c and 28c also serve to push out of the way an object which or a person who might otherwise be trapped between the closing barrier fence sections 26, 28, which preferably will not stop or retract if they encounter an obstacle which can be pushed aside. The barrier system may include sensors which will avoid imposing lethal force upon a person trapped between a closing barrier fence section and a rigid structure or between two closing barrier fence sections, yet will not open towards the undeployed position to easily release the trapped individual or object. Accordingly, bumpers 26c and 28c are preferably made of a soft material such as a soft foam rubber or the like in order to avoid or minimize injury of someone who is pinched between the closing panels. Because the barrier system is designed to respond to an emergency situation, for example, in reaction to an alarm or other signal indicating the presence of one or more intruders, the rate of closing of the barrier fence sections 26, 28 is desirably high.

Generally, it is preferred that only a short time-to-closure period be required for movement of the barrier fence from its undeployed, i.e., stowed, position in which the security area associated with the barrier system is open to passage therethrough by a person or persons, and its fully deployed position in which the barrier fence closes the security area to any such passage. Rapid closing will of course aid in frustrating the efforts of interlopers to penetrate the barrier system and it is preferred that the aforesaid time-to-closure period be not more than about 3 to 4 seconds although shorter or longer time periods, for example, for about 1 to about 10 seconds or more may be appropriate depending on the layout, dimensions and security needs of a given installation. For example, assume that a security barrier comprises a single barrier fence section which moves horizontally as illustrated (for a two-section barrier fence) in FIG. 3, that a time-to-closure period of about 3 seconds is required, and that the security barrier must close a 15-feet wide hallway. The single barrier fence would have to have a travel speed of about 5 feet per second. For another example, assume that the same conditions and requirements apply, but there are two barrier fence sections (26, 28 in FIG. 4) which move horizontally towards each other, as indicated by the unnumbered arrows in FIG. 3. In this case, each fence section would have a travel speed of about 2.5 fps to provide a closing rate of 5 fps and a 3 second time-to-closure period. While any desired closing speed may be utilized, as indicated above, in most cases a high closing speed and therefore a short time-to-closure period is desirable.

As seen in FIGS. 4 and 4A, (as noted above, open locker doors are omitted from FIG. 4A) when barrier fence 30 is fully deployed, transparent end panels 26a, 28a overlap and enable law enforcement or other security personnel to observe what is transpiring beyond the deployed barrier fence 30. After the situation which prompted deployment of the barrier fence, whether an emergency or a routine test of the system, the barrier fence may be undeployed, that is, returned to the storage lockers 14, 16 for stowage. This may be effectuated by either or both of the master control system and the secondary controls as described below.

The barrier fence is preferably constructed so that the joints between adjacent panels meet at least the same national standards for resistance to small arms fire as described above. That is, there should not be any places along the deployed barrier fence 30, including joints between panels, which fail to meet the above-noted national standards for resistance to penetration by small arms fire or projectile fragments.

Floor track 24 and overhead track 18 respectively engage the bottom (unnumbered) and top (unnumbered) of the deployed barrier fence sections 26, 28 to provide stability to them and thereby to resist a person or persons pushing against the deployed barrier fence sections 26, 28 which, in their fully deployed position illustrated in FIGS. 4 and 4A, cooperate to comprise barrier fence 30.

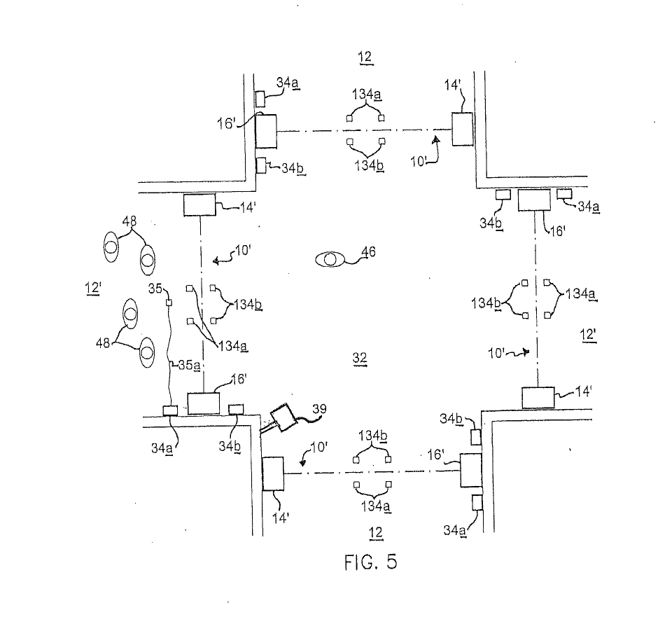

Referring now to FIG. 5, there is shown schematically a plan view of two hallways 12 and 12′ which perpendicularly intersect each other to define a common area 32. Four security barrier installations 10′ are shown schematically disposed at the intersection of hallways 12, 12′. A detection system 39, for example, a closed circuit television camera, is positioned to detect intruders. Each security barrier installation 10′ may be identical or similar to security barrier installation 10 illustrated in FIGS. 1-4A and each comprises associated storage lockers 14′ and 16′. Secondary control panels 34a, 34b are associated with each of their respective security barrier installations 10′. In each case, secondary control panels 34a and 34b are disposed on opposite sides of their associated security barrier installation 10′. Secondary control panels 34a and 34b are locked and may be opened only by personnel in possession of a customized, suitable unlocking device. The secondary control panels are operatively connected to the control system to operate the barrier fence to provide the limited access opening in the barrier fence, and may be located adjacent to the barrier fence. The secondary control panel may be responsive to a coded signal to unlock the secondary control panel. Once unlocked, the secondary control panel may be operated to move one or both of barrier fence sections 26, 28 (FIGS. 2 and 3A) at least partly towards the stowed or undeployed position in order to provide access through the barrier fence 30 (FIGS. 4 and 4A). As described in more detail below, only authorized personnel such as law enforcement or security personnel will be equipped with unlocking devices which enable them to open or partially open the security barrier fence to provide access through it.

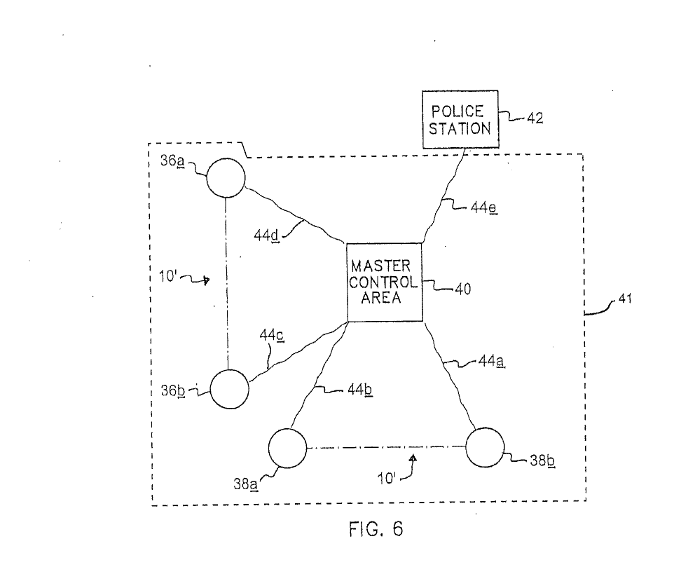

Referring now to FIG. 6, there is schematically illustrated a master control system to control operation of security barrier installations 10′, two of which are illustrated in FIG. 6 and comprise, respectively, drive motor pairs 36a, 36b and 38a, 38b. Two drive motors are operatively associated with each barrier fence section, such as barrier fence sections 26 and 28 shown in FIGS. 2 and 3A. Controls are contained in master control area 40 to operate one or both of the pairs of paired drive motors 36a, 36b and 38a, 38b when an intruder or intruders are detected by a detection system in an area to be secured. Such detection may of course be by personal observation, or by one or more detection devices such as closed circuit television cameras, motion detectors, infrared sensors or any suitable detection device or devices. Typically, master control area 40 will be a secure area which may be somewhat remote from the areas to be secured, e.g., hallways 12 and 12′ of FIG. 5 and/or the common area 32 where these hallways overlap. Master control area 40 may contain a bank of television monitors or other instruments receiving signals from the detection devices. Master control area 40 will also contain controls to operate the drive motors associated with the security barrier installation or installations 10′ to deploy the barrier fence sections 26, 28 (FIG. 4) to form barrier fence 30. Operation of the drive motors to form a barrier fence may be carried out by manual actuation of controls by an operator in response to detection signals. Alternatively, receipt of a detection signal may automatically actuate selected drive motors to deploy the barrier fences. It will be appreciated that any suitable drive train may be utilized to connect the drive motors to the barrier fence sections 26, 28. It will be appreciated from FIG. 5 that when a plurality of barrier fences are properly disposed relative to each other, when each of the plurality of barrier fences is in its fully deployed position they cooperate to define between or among them a fully enclosed or isolated security area, such as common area 32.

As schematically illustrated in FIG. 6, signals to the drive motors 36a, 36b and 38a, 38b and to a remote emergency response facility, such as a police station 42 may be sent along one or more communication paths, such as communication paths 44a, 44b, 44c, 44d and 44e. These communication paths may be electric transmission wires, wireless signals such as radio frequency or other signals or any suitable combination thereof. The communication device or system in the master control area is also equipped to automatically, upon deployment of the barrier fence, or independently, send a signal to the police station 42 to alert law enforcement officials that one or more barrier fences have been deployed and that assistance is needed at the sites of the security barrier installations. Obviously, the signal may be sent to a security force other than one located at a police station, for example, to a military installation in the case of intruders at a government facility, or to an on-site security force. In addition, an audio and/or visual or other alarm or signal may be sent to occupants of the building to shelter down and lock doors or, in an appropriate case, to evacuate the building via specified exits.

In use, once an intruder or intruders are detected, the appropriate security barrier installations 10′ are activated to block off selected areas of the building to be secured. Referring again to FIG. 5, assume that all four of the barrier fences of the security barrier installations 10′ have been deployed in response to the presence of intruders. Assume further that an intruder 46 is trapped by the deployed barrier fences within common area 32 and that law enforcement personnel 48 arrive at the scene and position themselves in hallway 12′ on the opposite side of a barrier 10′ from the intruder 46. Law enforcement personnel may observe the intruder through the transparent overlapping end panels 26a, 28a (FIGS. 4 and 4A). If the law enforcement personnel determine that the intruder 46 is prepared to surrender or that it is necessary to attack him with either lethal or non-lethal weapons, one of the law enforcement personnel will open the normally locked secondary control panel 34a and operate the secondary controls therein contained to at least partially open barrier fence 30 (FIGS. 4 and 4A) at least sufficiently to provide a limited access opening in the barrier fence to enable law enforcement personnel to enter the common area 32 to effectuate capture or disablement of the intruder 46. Of course, the barrier fence 30 may also be at least partially opened by the master control system.

Alternatively, or in addition to partially opening the barrier fence, a locked access panel 28d (FIG. 4A) may be provided in the barrier fence 30. Access panel 28d may be opened by an authorized person provided with a key or other opening device to provide such limited access opening in the fully deployed barrier fence 30. Alternatively, or in addition, access panel 28d may be unlocked or opened via the control system.

The secondary control panels 34a and 34b obviously must not be capable of being opened by the intruder 46 or by anyone other than authorized personnel. Control of the ability to open any of the secondary control panels 34a, 34b to enable operating the barrier fence to at least partially open it may be attained by providing law enforcement or other authorized personnel with a mechanical or electronic key to open the secondary control panels. One way to effectuate this is to provide the authorized personnel with a radio frequency identification (“RFID”) module which is recognized by the lock securing the secondary control panels 34a, 34b. Law enforcement personnel may be provided such RFID modules upon their arrival at the site, or they may routinely carry such RFID modules on their persons in anticipation of being called to the installation site. For example, the RFID module may be incorporated into the law enforcement officer's uniform, cap, belt or any other convenient location. Another way of providing access to the controls of the secondary control panels 34a, 34b is to provide a suitable key, RFID module, etc., in a Knox box permanently installed at the building site. Such Knox boxes are well known and typically one or more are permanently installed in buildings so that fire fighters or emergency personnel of any kind who have been supplied with keys to open the Knox box may open the Knox box to access RFID modules, keys or the like needed to operate fire doors, elevators and the like in an emergency. RFID modules, keys or the like to operate the secondary controls of barrier fence 30 may be kept in one or more Knox boxes.

It is desirable for law enforcement or other security personnel to be able to partially open barrier fence 30 at any point along the barrier fence, especially at the point or points where transparent panels or other transparent sections may be located. Although the illustrated embodiments show the transparent panels as being provided at the point where the end panels of the barrier fence sections 26, 28 overlap, it is obvious that transparent panels or sections may also or alternatively be located at different points along the deployed barrier fence 30. The ability to control at least partial opening of the barrier fence 30 from a location where the operator can observe through the transparent panels or sections the intruder or intruders and their actions is highly advantageous. A number of expedients are available to enable law enforcement or security personnel to at least partially open the deployed barrier fence 30 (FIGS. 4 and 4A) at selected points along its length. For example, FIG. 5 schematically shows secondary control panels being provided as floor-mounted secondary pedal control panels 134a, 134b. The pedal control panels, like the secondary control panels 34a, 34b, are disposed on either side of the barrier fence 30 and may be accessed only by those who are provided with an RFID module, key or the like to access the secondary control panels, which are conveniently operated by foot pedals. As illustrated, secondary pedal control panels 134a, 134b are positioned near the center of barrier fence 30 where, in the illustrated embodiments at least, the transparent panels are located. The secondary pedal control panels may be located at any convenient point or points along barrier fence 30 at both sides thereof.

FIG. 5 also shows, with respect to only one of the secondary control panels 34a, a portable secondary control 35. Secondary control 35 is a hand-held device which is secured within secondary control panel 34a. Law enforcement or other authorized personnel, once they open secondary control panel 34a, may remove the portable hand-held secondary control 35 to operate barrier fence sections 26, 28 to at least partially open barrier fence 30. An extension cord 35a is shown connected to portable secondary control 35. Portable secondary control 35 could be wireless operated, thereby obviating the need for extension cord 35a. Both secondary pedal control panels 134a, 134b and a hand-held portable secondary control 35, or only one of them, may be provided.

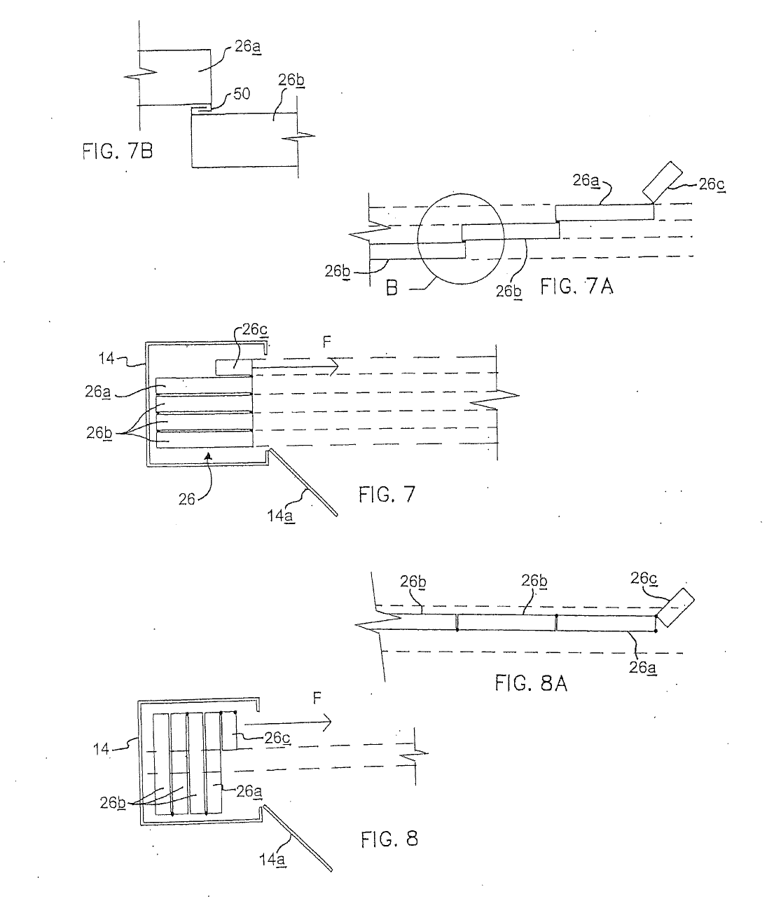

FIG. 7 is a schematic plan view showing storage locker 14 of FIGS. 1, 2 and 3 having therewithin a stowed barrier fence section 26 comprised of a transparent end panel 26a and a plurality of interior panels 26b. The panels are hinged so that when the door 14a is opened by actuation of the drive motor associated with barrier fence section 26 and a control drive (not shown) exerts a force as indicated by the arrow F in FIG. 7. The panels will unfold and deploy into the extended staggered configuration shown in FIG. 7A. In addition to the hinges, as shown in FIG. 7B, individual panels are interlocked by engagement members 50 to extend the panels 26a, 26b into the configuration shown in FIG. 7A in order to deploy the barrier fence 30. The bumpers 26c, 28c are illustrated in FIGS. 7-8A as being connected to respective end panels 26a, 28a. Not shown is a locking mechanism which will lock the bumpers into their angled positions upon deployment of the barrier fence. Alternatively, bumpers 26c, 28c could be permanently rigidly affixed to their associated end panels at the appropriate angle.

FIG. 8 shows an alternate embodiment in which the panels 26a, 26b are hinged so that an imposition by the drive control (not shown) of a force indicated by the arrow F in FIG. 8 will extend the panels in an aligned fashion for deployment as shown in FIG. 8A.

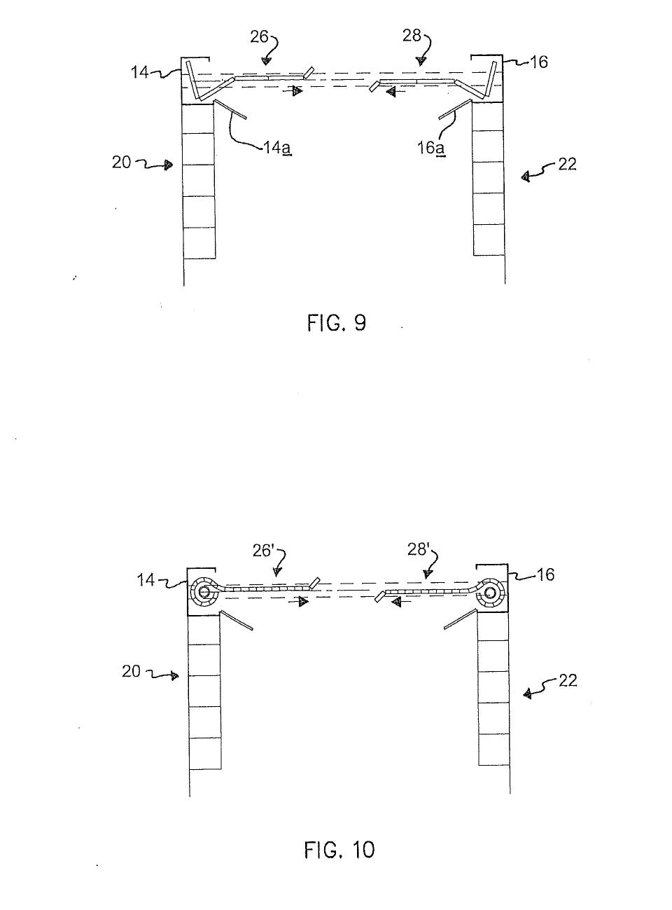

FIG. 9 shows the partial deployment of barrier fence sections 26, 28 from storage as illustrated (for barrier fence section 26) in FIG. 8.

FIG. 10 shows an alternate embodiment in which instead of folded and hinged panels, barrier fence sections 26′ and 28′ are comprised of respective vertically oriented rolls of ballistic material which are deployed by being spooled from respective vertical shafts 52a, 52b. Overhead and floor tracks (not shown in FIG. 10) help to hold the deployed barrier fence sections 26′, 28′ in place.

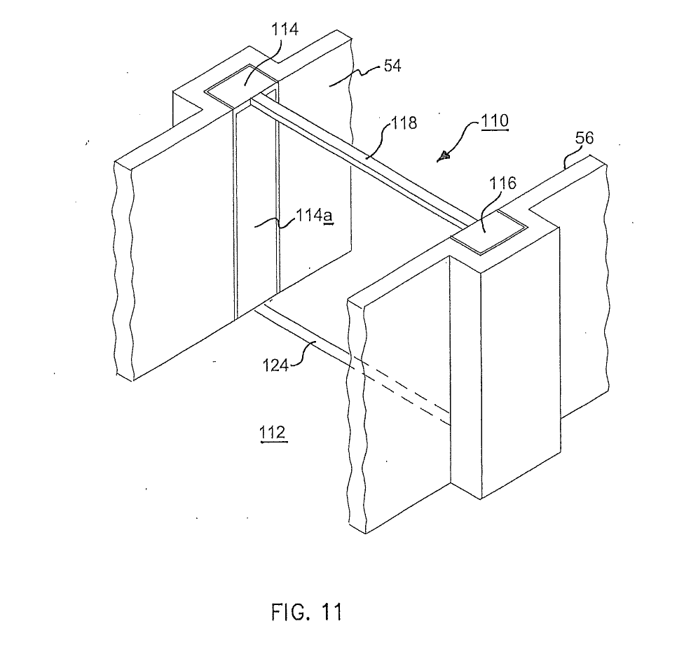

FIG. 11 shows another embodiment of a security barrier installation 110 in accordance with another embodiment of the present invention. In this case, storage lockers 114 and 116 are built into the walls defining hallway 112 so that the door 114a of storage locker 114 is flush with the wall 54. The door of storage locker 116, not visible in FIG. 11, is similarly flush with the inner surface of the wall 56 opposite the wall 54. An optional overhead track 118 and an optional floor track 124 are provided as in the other embodiments. Floor track 124 is located in the floor of the security area and extends along the travel path of the barrier fence. The bottom of the barrier fence engages the floor track during movement of the barrier fence between the undeployed and fully deployed positions. The overhead track 118 extends along the travel path of the barrier fence and the top of the barrier fence engages the overhead track 118 during movement of the barrier fence between the undeployed and fully deployed positions. It will be appreciated that the embodiment of FIG. 11 is well suited for new construction wherein the security barrier installation is installed in connection with construction of the building.

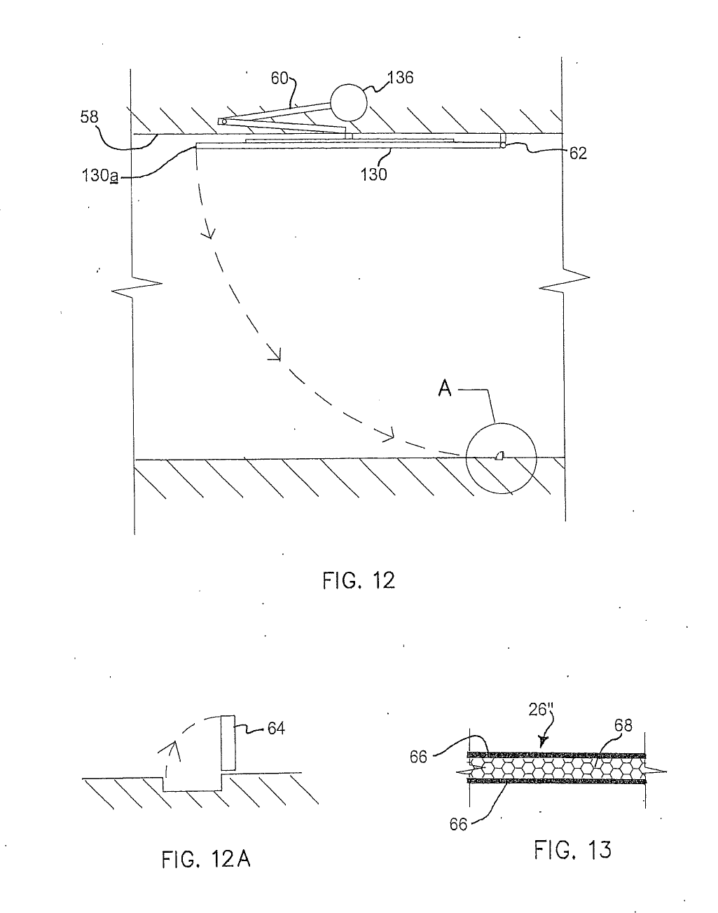

FIG. 12 is a schematic view in which a barrier fence 130 is mounted in or adjacent a ceiling 58 for operation by a drive member 60 by a drive motor 136. Upon deployment, barrier fence 130, which is connected by hinge 62 to ceiling 58, is deployed in the arc indicated by the unnumbered curved arrow in FIG. 12 to engage a lip 64 (FIG. 12A) which normally covers recessed floor track 124. Lip 64 is automatically raised to the position indicated in FIG. 12 upon actuation of the drive motor 136 and helps to stabilize the lower end 130a of barrier fence 130 when it is deployed. It will be appreciated that depending on the width of the hallway or other area to be sealed off, barrier fence 130 may comprise a single unitary fence or it may be comprised of a series of adjacently disposed fences. A section of barrier fence 130 may be comprised of a transparent ballistic material for the reasons described above. In addition to the ballistic characteristics of the panels, desirably the panels may also be made fire-resistant. FIG. 13 shows a segment of a panel 26″ comprising a pair of spaced apart bullet-resistant panels 66 which sandwich between them a suitable fire-resistant material 68.

Supplemental features such as audio, visual and dispensing devices for incapacitating agents may be provided to supplement the deployable barrier fence system disclosed above. Controls for such supplemental features could be automatically operated upon deployment of the barrier fence or selectively as needed by a human operator. For example, alarms, smoke, painfully loud and disconcerting noises, blinding and flashing lights such as strobe lights, may be suitable to use in certain environments to distract, disorient and/or inhibit or prevent communication between or among multiple intruders. In addition, incapacitating agents such as tear gas, other temporary disabling gases or sprays, etc., may be employed. These supplemental features would be more appropriate for environments such as warehouses where there is not present an innocent population such as one would find in schools, or office and apartment buildings. However, one or more of the supplemental features may be used after hours in schools or other buildings occupied by the public during normal operating hours. Further, in an apartment building it may be appropriate to have such supplemental devices in place because the innocent population may be expected to be within their apartments behind closed doors while the disabling or distracting agents could be employed, if the situation warrants, in the hallways or corridors. In such cases, it would be preferable that the supplemental features be selectively operated by a security person instead of automatically upon deployment of the barrier fence.

It will appreciated that the disclosed system provides rapid, nearly instantaneous deployment of a barrier fence to isolate selected areas of a building to impede freedom of movement of an intruder and/or trap the intruder within a selected area. Responding law enforcement or other personnel can observe the tactical situation through the transparent panels and may open the deployed barrier fence sufficiently to gain access to the intruder or other area. Optionally, disorienting, distracting and/or temporarily disabling supplemental features may also be deployed.

While the invention has been described in connection with specific embodiments thereof, it will be appreciated that numerous other embodiments which lie within the scope of the present invention may be readily devised based on the disclosure contained herein.

What is claimed is:

1. A security barrier system for closing a security area to passage therethrough by a person or persons, the barrier system comprising:
at least one deployable barrier fence which is movable between an undeployed position in which the barrier fence is disposed in a first location in which the security area is open to passage therethrough by a person or persons, and a fully deployed position in which the barrier fence is disposed in a second location different from the first location, whereby the security area is closed to any such passage therethrough, the barrier fence being comprised of a ballistic material along substantially its entire length, and at least a portion of the barrier fence is transparent to permit observation of the security area through the barrier fence;
a control system operatively connected to the barrier fence and capable of being activated to move the barrier fence between the undeployed position and the fully deployed position;
wherein the barrier fence is configured to enable, at a selected time after the barrier fence is in the fully deployed position, formation in the fully deployed barrier fence of at least one limited access opening to the security area.

2. The system of claim 1 wherein the control system and the barrier fence are configured to provide the limited access opening by moving the barrier fence from the fully deployed position to an intermediate partially deployed position between the fully deployed and undeployed positions, to thereby provide the at least one limited access opening to the security area through the partially deployed barrier fence.

3. The system of claim 1 wherein the barrier fence is configured to open at least one section of the fully deployed barrier fence to provide the at least one limited access opening to the security area through the fully deployed barrier fence.

4. The system of claim 1 wherein at least a portion of the barrier fence is sufficiently transparent to permit observation of the security area through the barrier fence.

5. The system of claim 1 wherein the barrier fence comprises a pair of barrier fence sections having respective free ends, which barrier fence sections are movable in a horizontal travel path between the undeployed and fully deployed positions of the barrier fence and the free ends of the barrier fence sections overlap each other when in the fully deployed position to provide an overlapped section of the barrier fence.

6. The system of claim 5 wherein the barrier fence sections are comprised of a ballistic material along substantially their entire length and the transparent portion is comprised of a ballistic glass material.

7. The system of claim 1 further comprising one or more communication paths which automatically transmit signals to a remote emergency response facility when the control system is activated to move the barrier fence from the undeployed position to the fully deployed position.

8. The system of claim 1 wherein the barrier fence is comprised of a series of hinged panels which are folded upon each other into a stack when the barrier fence is in the undeployed position, and which open into a linear array of panels as the barrier fence is moved into the fully deployed position.

9. The system of claim 1 further comprising a detection system which detects the presence of an intruder or intruders in the security area while the barrier fence is in the undeployed position and transmits an alarm to alert security personnel to activate the control system to move the barrier fence to the fully deployed position.

10. The system of claim 1 further comprising a detection system which detects the presence of an intruder or intruders in the security area while the barrier fence is in the undeployed position and transmits an alarm which automatically signals the control system to move the barrier fence to the fully deployed position.

11. The system of claim 1 wherein the barrier fence when in the undeployed position is comprised of a roll of material which is unrolled into a linear configuration as the barrier fence is moved into the fully deployed position.

12. The system of claim 1 wherein the barrier fence has a top and a bottom and is comprised of a pair of barrier fence sections which are movable along a floor of the security area in a horizontal travel path between the undeployed and fully deployed positions of the barrier fence, with the bottom of the barrier fence disposed at or adjacent to the floor of the security area.

13. The system of claim 12 wherein movement of the barrier fence sections from the undeployed position to the fully deployed position takes from about 1 to about 10 seconds.

14. The system of claim 12 wherein movement of the barrier fence sections from the undeployed position to the fully deployed position takes from about 3 to about 4 seconds.

15. The system of claim 12 further comprising a floor track in the floor of the security area and extending along the travel path of the barrier fence, and wherein the bottom of the barrier fence engages the floor track during movement of the barrier fence between the undeployed and fully deployed positions.

16. The system of claim 12 further comprising an overhead track extending along the travel path of the barrier fence and wherein the top of the barrier fence engages the overhead track during movement of the barrier fence between the undeployed and fully deployed positions.

17. The system of claim 1 comprising a plurality of barrier fences disposed relative to each other whereby when each of the plurality of barrier fences is in its fully deployed position they cooperate to define between or among them a fully isolated security area.

18. The system of claim 1 further comprising a secondary control panel which is locked against unauthorized access to it, and is operatively connected to the control system to operate the barrier fence to provide the limited access opening in the barrier fence.

19. The system of claim 1 wherein when in the undeployed position the barrier fence is stowed out of sight.

20. A security barrier system for closing a security area to passage therethrough by a person or persons, the barrier system comprising:
at least one deployable barrier fence;
a control system operatively connected to the barrier fence to move the barrier fence between an undeployed position in which the barrier fence is disposed in a first location in which the security area is open to passage therethrough by a person or persons, and a fully deployed position in which the barrier fence is disposed in a second location different from the first location, whereby the security area is closed to any such passage therethrough;
wherein the barrier fence is comprised of a series of hinged panels comprised of a ballistic material, the panels being folded upon each other into a stack when the barrier fence is in the undeployed position and opening into a linear array of panels as the barrier fence is moved into the fully deployed position, and the control system is operative to provide in the barrier fence, at a selected time after the barrier fence is in the fully deployed position, a limited access opening to the security area by moving the barrier fence from the fully deployed position to an intermediate partially deployed position between the fully deployed and undeployed positions.

21. The system of claim 20 wherein at least one of the deployed panels is transparent.

22. The system of claim 20 comprising a plurality of barrier fences disposed relative to each other whereby when each of the plurality of barrier fences is in the fully deployed position they cooperate to define between or among them a fully enclosed security area.

23. A method of controlling a security area by closing the security area to passage therethrough by a person or persons, the method comprising:
deploying one or more barrier fences of a security barrier system from an undeployed position in which the barrier fence is disposed in a first location in which the security area is open to passage therethrough, to a fully deployed position in which the one or more barrier fences are disposed in a second location different from the first location, whereby the security area is closed to such passage, and positioning the barrier fences to fully enclose the security area when the barrier fences are in their respective fully deployed positions.

24. The method of claim 23 further comprising operating at least one of the barrier fences to form, at a selected time after the barrier fences are in their fully deployed positions, a limited access opening to the security area in at least one of the barrier fences.

25. The method of claim 23 wherein at least one of the barrier fences is transparent at least at a portion thereof, and observing the security area through the transparent portion or portions.

26. The method of claim 23 wherein the barrier system further comprises an alarm system which upon detecting the presence of one or more unauthorized persons in the security area automatically triggers a control system operatively connected to the barrier fences to move the barrier fences to their fully deployed position.

27. The method of claim 26 further comprising stowing the one or more barrier fences out of sight in the undeployed position.
